(19) United States
(12) Patent Application Publication
(10) Pub. No.: US 2008/0268791 A1
(43) Pub. Date: Oct. 30, 2008

(54) Systems And Methods For Connecting Life Experiences And Shopping Experiences

(76) Inventor: Yevgenly Eugene Shteyn, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/741,764

(22) Filed: Apr. 29, 2007

(51) Int. Cl. H01Q 1/38; G01S 1/00; H04B 1/10; H04B 1/38; H04J 1/00; H04J 11/00

(52) U.S. Cl. 455/73; 327/557; 342/350; 343/700 MS; 370/203; 370/281; 370/310

(57) ABSTRACT

Systems and methods of connecting life experiences to a shopping experience are disclosed. An exemplary embodiment of a method includes receiving user-input identifying at least one position in a life experiences continuum. The method also includes recalling digital content for the shopping experience based on the at least one position selected by the user in the life experiences continuum.

### BACKGROUND

Digital content distribution services are now commonly available to most consumers in the form of websites that allow users to download a wide variety of digital material over the Internet including but not limited to, music, television programs, movies, and even electronic books (or “e-books”). The website may either charge the user a monthly access fee, or a per-use fee (e.g., similar to purchasing a DVD at the store). To access the digital content, the user may logon to the website as a member, search for digital content of interest, and then stream the digital content “live” or download the digital content for later playback.

Most digital content distribution services have taken the same approach to merchandising as their so-called “brick-and-mortar” counterparts. That is, the content is typically organized for the user on the website in standard retail categories according to genre, ratings, new releases, other user recommendations, etc. This approach to merchandising makes it difficult to distinguish one provider website from another, and can even become boring to the user because this approach to merchandising ignores any connection to the user's life experiences. Accordingly advertising and sales on these websites suffer.

### BRIEF DESCRIPTION OF THE DRAWINGS

FIG. 1 is a high-level illustration of an exemplary networked computer system which may be implemented for connecting life experiences to a shopping experience.

FIG. 2 is a schematic illustration of exemplary functional modules of an interlace engine for connecting life experiences to a shopping experience.

FIG. 3 is a high-level diagram illustrating an exemplary continuum for connecting life experiences to a shopping experience.

FIGS. 4 and 4a-c are exemplary graphical user interfaces which may be implemented for connecting life experiences to a shopping experience.

FIG. 5 is a flowchart illustrating exemplar operations which may be implemented for connecting life experiences to a shopping experience.

### DETAILED DESCRIPTION

Briefly, systems and methods described herein may be implemented to relate life experiences (real or imagined life experiences) to a user's shopping experience. In an exemplary embodiment, the user is presented with shopping scenarios based on a space-time continuum (e.g., “what movies were popular in my hometown, when I was a child?”). For example, “what would be my entertainment options, including movies, songs, and books, if I lived in Italy twenty years ago?” Or for example, “what would life on Mars after 2050 look like according to current and past movies, TVs, and books on the subject?” Or in another example, “What TV shows would my girlfriend, born arid raised in New York, most likely have watched when she was in high school?” Of course other continuums in addition to space-time may also be implemented, as will be readily appreciated from an understanding of the following discussion with reference to the figures. Such an approach results in higher website “hit rates” and creates brand loyalty.

### Exemplary Systems

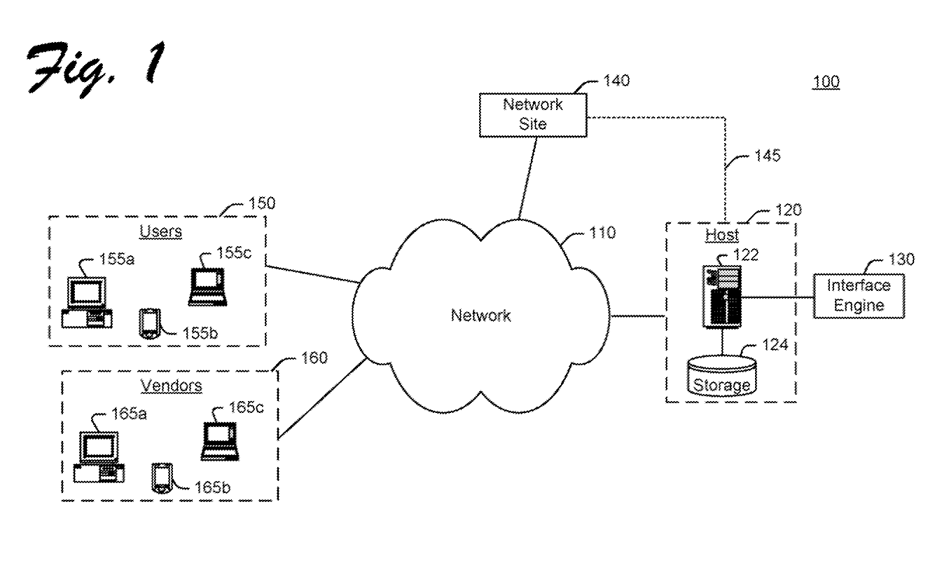

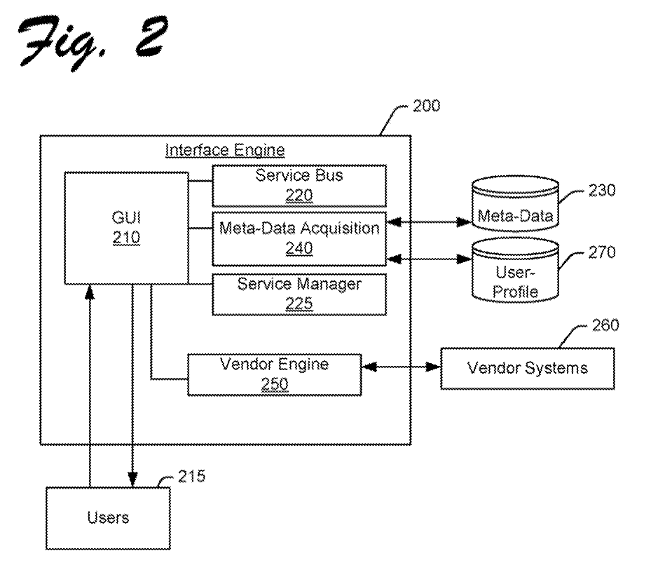

FIG. 1 is a high-level illustration of an exemplary networked computer system 100 (e.g., the Internet) which may be implemented for connecting life experiences to a shopping experience. The networked computer system 100 may include one or more communication networks 110, such as a local area network (LAN) and/or wide area network (WAN). A host 120 may be implemented in the networked computer system 100 for connecting life experiences to a shopping experience for a user.

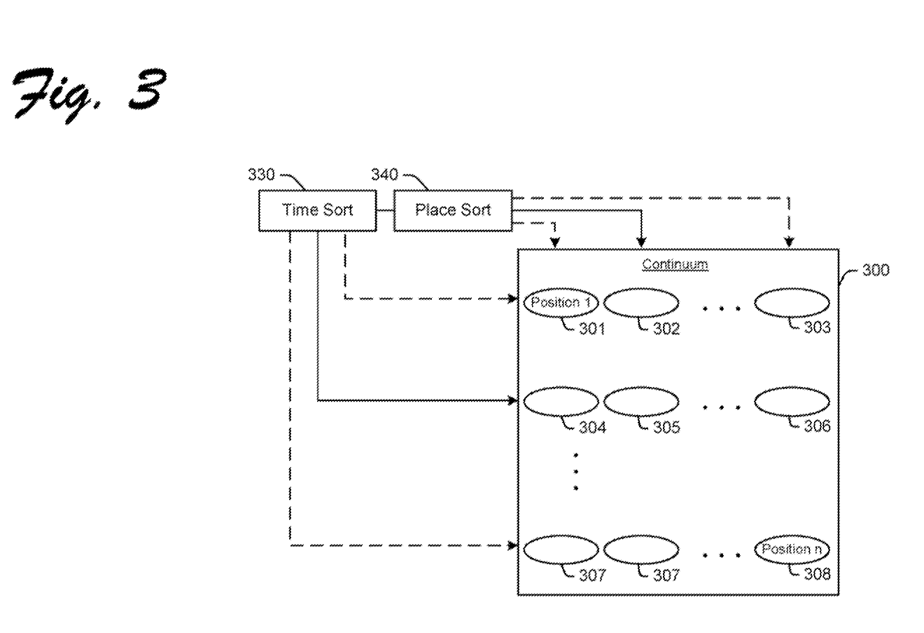

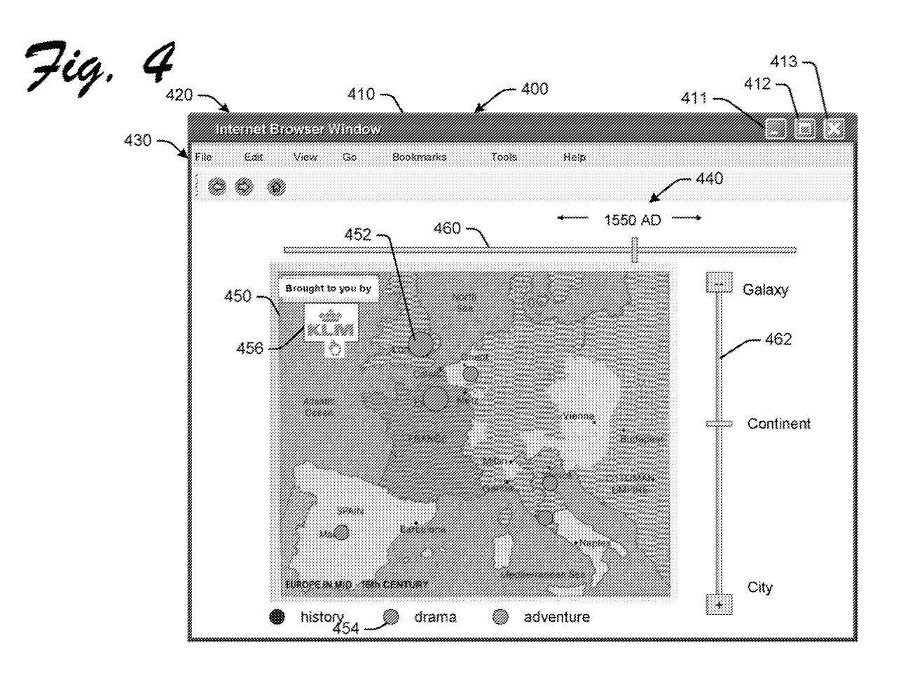

Host 120 may include one or more computing systems, such as a server 122 with computer-readable storage 124. Host 120 may execute an interface engine 130 implemented in software, as described in more detail below with reference to FIG. 2. Host 120 may also provide services to other computing or data processing systems or devices. For example, host 120 may also provide transaction processing services, email services, etc.

Host 120 may be provided on the network 110 via a communication connection, such as a dial-up, cable, or DSL connection via an Internet service provider (ISP). Host 120 may be accessed directly via the network 110, or via a network site 140. In an exemplary embodiment, network site 140 may also include a web portal on a third-party venue (e.g., a commercial Internet site), which facilitates a connection for one or more clients with host 120 (e.g., via back-end link 145). In another exemplary embodiment, portal icons may be provided (e.g., on third-party venues, pre-installed on computer or appliance desktops, etc.) to facilitate a direct link to the host 120.

The term “client” as used herein refers to a computing device through which one or more users may access the interface engine. For purposes of illustration, a client may have one or more users 150 accessing network 110 via computing devices 155a-e. A client may also include one or more merchant or vendor 160 accessing network 110 via computing devices 165a-e. Still other types of users may also access the system 100. It is also noted that the terms “client” may be used interchangeably herein with the terms “user” and “vendor”.

Before continuing, it is noted that computing devices 155 and 165 may include any of a wide variety of computing systems, such as a stand-alone personal desktop or laptop computer (PC) 155c and 165c, workstation 155a and 165a, personal digital assistant (PDA) 155b, 165b, mobile phone, or appliance, to name only a few examples. Each of the computing devices may include memory, storage, and a degree of data processing capability at least sufficient to manage a connection to the interface engine 130 either directly via network 110 to host 120 or indirectly (e.g., via network site 140). Computing devices may connect to network 110 via a communication connection, such as a dial-up, cable, wireless, or DSL connection via an Internet service provider (ISP).

In an exemplary embodiment the user is presented with “time machine” shopping scenarios based on a multi-modal continuum (e.g., time-space continuum). These and other functional operations to implement the continuum may be better understood with reference to the interface engine described below for FIG. 2.

FIG. 2 is a schematic illustration of exemplary functional modules of an interface engine 200 for connecting life experiences to a shopping experience. Exemplary interface engine 200 may be implemented in computer-readable program code executable by one or more computing systems in a network such as, e.g., the Internet. For example, interface engine 200 may be a web-based application executing at a network server (e.g., server 122 in FIG. 1) and various functional modules may be implemented as applets or script executing at a computing device (e.g., computing devices 155 and 165 in FIG. 1).

Interface engine 200 may be implemented as one or more functional modules, as illustrated in FIG. 2. For example, these modules may include a graphical user interface (GUI) module 210, a service bus 220, a service manager 225, metadata 230, a acquisition modules 240 (referred to as a meta-data acquisition module when accessing the meta-data 230), and a user profile database 270.

In an exemplary embodiment, the GUI module 210 is responsible for instantiation and operation of various user interfaces. The user interfaces are created and presented to the user 215 based on parameters such as, but not limited to, user preferences, access device configuration (e.g. screen size, bandwidth, security, and/or default settings). The GUI module 210 enables the user to interact and browse a variety of digital content, place orders, specify content delivery options (e.g. download, mail, etc.), follow links to advertised goods and services, rate content and presentation, switch interface mode, express and store preferences, interact with other users, etc.

The GUI module 210 can instantiate a user interface with any combination of parameters. Optionally, the user may change and save parameters to set up preferred interfaces for different devices or service providers. For example, for a cable TV service provider, the default may be set to the following values: Interface Type=“Table,” Target device=“TV,” Language=“English,” and Bandwidth=“High.” The user may change the same parameters to the following values: Interface Type=“Map,” Target device=“mobile,” Language=“Chinese,” and Bandwidth=“Medium.”

In the above example, the Interface Type parameter relates to the semantics of the interface presented. For purposes of illustration, the Interface Type parameter “Table” refers to a table view that lists digital content at a given location. For example, digital content may be displayed for the following time-space continuum: “when I was 23 in 1990 and living in New York, N.Y.” The table lists theater releases, television shows, sports events, music videos, and books that were most popular in New York City in 1990, when the user was 23. Optionally, the user can sort entries in the table, e.g., by popularity, by applying genre filters (comedy, drama, thriller), and other local data manipulations. Such manipulations may be implemented, e.g. by utilizing XML-based AJAX programming interfaces.

Also for purposes of illustration, the Interface Type parameter “Map” refers to an interface displayed as an interactive map, wherein the user can click or mouse over a geographic location in the map to see content recommendations. By clicking on the map, the user may open a recommendation table, or transition to another, more focused recommendation tool (e.g. by relevancy, genre, six-degrees navigation, etc.). The map representation can be stored locally or accessed remotely via a set of Service APIs, such as readily available Google Map APIs. The graphic representation of the map can be adapted according to user profile data. For example, a child is provided with a simplified world map, wherein descriptive text information is substituted with semantically equivalent icons or pictures.

Still other interfaces are contemplated. For example, another interface type may comprise a hybrid map-table interface wherein major metropolitan areas are shown on the map accompanied by content description tables. In this embodiment, a table is displayed when the user moves a pointing device (e.g., computer mouse) over an active space-time location. The user is enabled to launch a media snippet, e.g. a video trailer or an audio clip, by clicking on a link embedded in the table.

Also in the above example, the Target Device parameters may be optimized for different target devices. For example, the user interface for output on televisions may be instantiated in compliance with the Consumer Electronics Association's (CEA) R7 Home Network Committee standard, CEA-2014. In another example, the user interface for output on personal computers may be optimized for Microsoft Internet Explorer 7.0. It is also noted that the user may download digital content to a device other than the device displaying the interface. For example, the user may access the interface using a mobile phone and purchase digital content to be downloaded to an Internet-connected digital video recorder, gaming device, home server, etc.

Also in the above example, the Language parameter may be set for a specific, language. The technique is generally known in the art as localization. The Bandwidth parameter may be optimized for different bandwidth environments. For example, a low bandwidth interface is designed with low graphic content. In another example, a low bandwidth interface contains links to low resolution video trailers.

The service manager 225 is responsible for invoking services specified by merchandising application logic. During run-time, the service manager 225 instantiates services according to the application logic. For example, a merchandising application that deploys map-based user interfaces instantiates services that access external map APIs, local meta-data access APIs, data mashup service (a service that combines content from more than one source), shopping cart service, and etc. In another example, for an advertisement application additional advertisement meta-data access and advertisement matching services are instantiated.

The service bus module 220 provides component management infrastructure for application execution run-time. The service bus module 220 may be implemented according to general requirements of Service-Oriented Architecture (SOA).

The meta-data database 230 contains content descriptors that can be provided to interface engine 200, e.g., via the meta-data acquisition module 240. For example, the meta-data database 230 may contain information associated with digital content that are intended for purchase, download, and other uses. The information may include at least location and time data that is used for presenting a particular content item via the interlace engine 200. Other data may include popularity ratings within specific media markets, user tags, recommendations, and etc.

The meta-data acquisition module 240 is responsible for accessing meta-data stored in the meta-data database 230, e.g., by acquiring, parsing, and storing meta-data. User profile database 270 also feeds the meta-data acquisition module 240 to enable creation of customized GUIs for the user. In an exemplary embodiment, meta-data acquisition module 240 may access external sources for information relevant to content items. The technique is generally known in the art as “mashup.” The meta-data acquired is similar in structure to that which is stored in the meta-data database, but is provided by a third-party run-time service.

Optionally, a vendor engine 250 may be provided. Vendor engine 250 enables the interface engine 200 to interact with vendor systems 260. For example, vendor engine 250 may receive information about digital content available from various vendors. Or for example, vendor engine 250 may receive advertising content from various vendors. Optionally, the vendor engine 250 may be used to redirect sales to vendor systems 260.

It is noted that exemplary interface engine 200 is shown and described herein for purposes of illustration and is not intended to be limiting. For example, the functional components shown in FIG. 2 do not need to be encapsulated as separate modules. In addition, other functional components (not shown) may also be provided and are not limited to those shown and described herein.

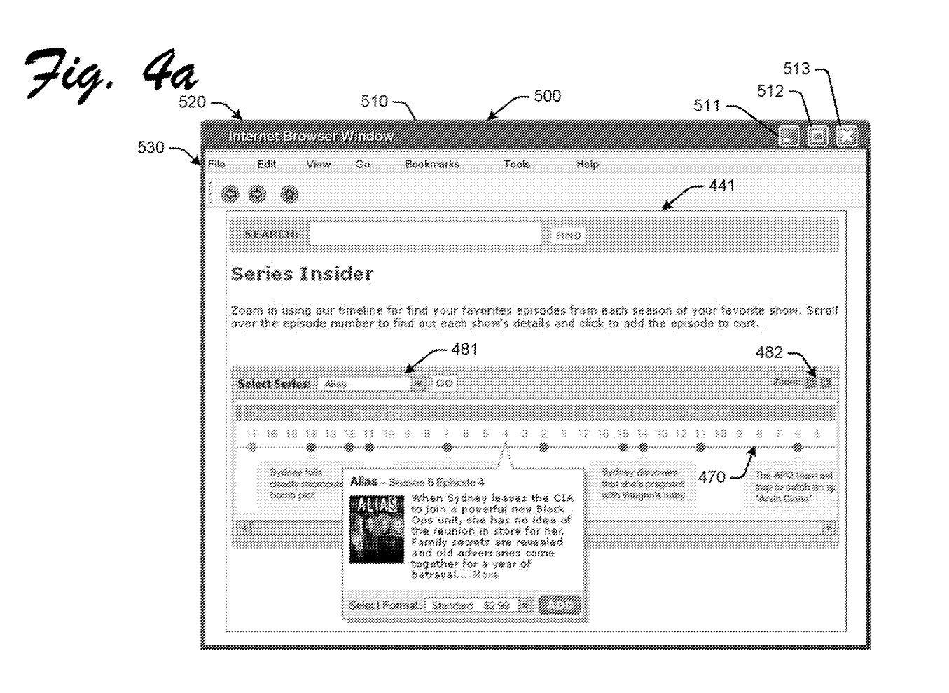

FIG. 3 is a high-level diagram illustrating an exemplary continuum 300 for connecting life experiences to a shopping experience. One or more continuums 300 may be implemented to categorize and locate digital content (e.g., media products and/or services) based on user-selected parameters (e.g., time and space), or “positions” in the continuum 300.

Although only one continuum is shown in FIG. 3, separate continuums may be used for separate categories (and/or subcategories), e.g., so that a user looking at a particular geographic location is placed into the corresponding continuum. Of course any number of continuums and sub-continuums may be implemented (e.g., for different genre within a category such as music).

The interface engine may use one or more sort mechanisms (e.g., time sort 330 and place sort 340) to identify positions 301-308 in the continuum 300. The position may be passed to the interlace engine which “points” to one or more position 301-308 in the continuum 300 based on the user-selected parameters. Digital content (e.g., media products and/or services) corresponding to the position 301-308 may then be retrieved and displayed for the user.

It is noted that a similar mechanism may be implemented for sorting digital content from vendors and putting the digital content into the continuum(s). The vendor's position in the continuum may be determined on a FIFO basis or other suitable algorithm (e.g., paying vendors may receive a higher position in the continuum than non-paying vendors).

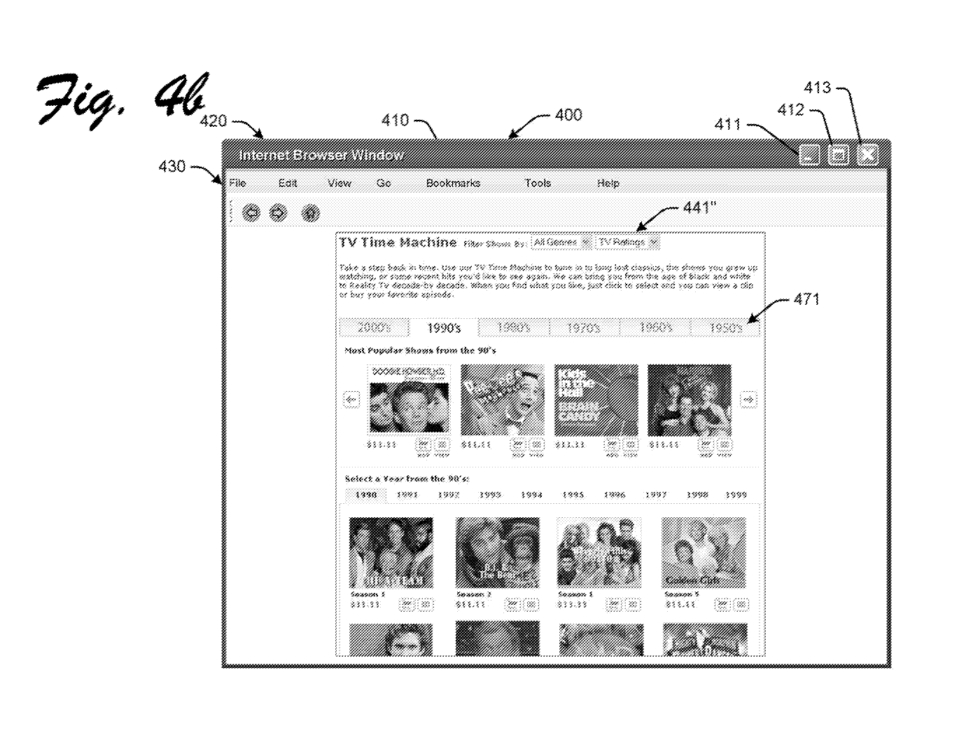

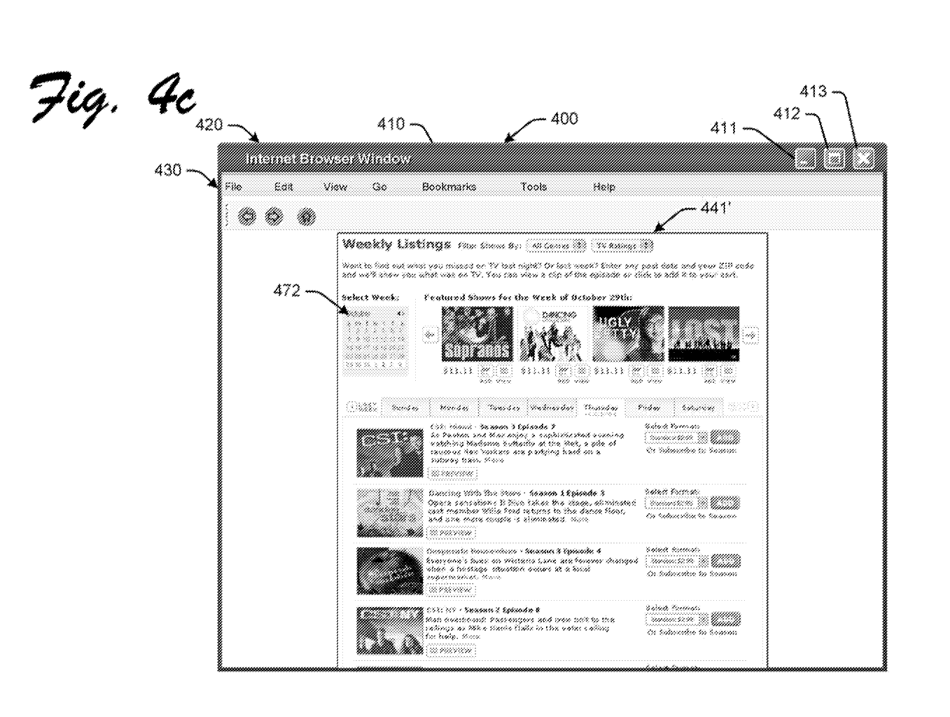

FIGS. 4 and 4a-c are exemplary graphical user interfaces which may be implemented for connecting life experiences to a shopping experience. In an exemplary embodiment, the browser interface 400 may be implemented as a graphical user interface (GUI) in a “windows-based” operating system environment (e.g., Microsoft Corporation's WINDOWS®), although the browser interface 400 is not limited to use with any particular operating system. The user may launch the browser interface 400 in a customary manner, for example, by clicking on an icon, selecting the program from a menu, or pressing a key on a keyboard.

The browser interface 400 supports user interaction through common techniques, such as a pointing device (e.g., mouse, style), keystroke operations, or touch screen. By way of illustration, the user may make selections using a mouse to position a graphical pointer and click on a label or button displayed in the browser interface 400. The user may also make selections by entering a letter for a menu label while holding the ALT key (e.g., “ALT+letter” operation) on a keyboard. In addition, the user may use a keyboard to enter command strings (e.g., in a command window).

The browser interface 400 is displayed for the user in a window, referred to as the “application window” 410, as is customary in a window environment. The application window 410 may include customary window functions, such as a Minimize Window button 411, a Maximize Window button 412, and a Close Window button 413. A title bar 420 identifies the application window 410 for the user (e.g., as “Internet Browser Window”). The application window 410 may also include a customary menu bar 430 having an assortment of pull down menus (e.g., labeled “File,” “Edit,” “View,” “Go,” “Bookmarks,” “Tools,” and “Help”), which are well-known in commercially available browser interfaces 400. For example, the user may select a print function (not shown) from the “File” menu (designated herein as “File|Print”). Although not shown, the graphics may also include, but are not limited to, subordinate windows, dialog boxes, icons, text boxes, buttons, and check boxes.

Application window 410 also includes an operation space 440. Operation space 440 may include one or more graphics for displaying output and/or facilitating input from the user. In FIG. 4, the operation space 440 shows a map 450 with a slider 460 which enables the user to navigate in time, and a slider 462 which enables the user to navigate in space. During navigation, the map is replaced based on the time-space parameters provided by the user. For example, different countries are displayed depending on the year selected in time. Alternatively, one or more slider may enable the user to navigate by other parameters, e.g., famous people, such as emperors, actors, directors, etc., and the slider position displays the name and/or a picture of a famous person.

Circles 452 appearing on the map 450 denote availability of digital content e.g., the bigger the circle the more content that is available. The user is also enabled to choose different genre, e.g. history, drama, adventure, and etc., by pressing a corresponding color button 454 on the bottom of the interface. An advertisement 456 may also be displayed. For example, the user may order airline tickets or travel packages by selecting the advertiser's logo or text-based advertising.

In FIG. 4a, the operation space 441 shows a timeline 470 for selecting movies. In this example, the user selected the United States as the space parameter, and then television shows from the 2000's as the time parameter. The user can then select a particular television series using drop box 480, then zoom in using zoom buttons 482 to see a brief description of the episodes.

In FIG. 4b, the operation space 441′ shows notebook tabs 471 for selecting the time parameter. In this example, the user selected the 1990's tab as the time parameter. The user can then select a particular television series by clicking on the corresponding icon.

In FIG. 4c. the operation space 441″ shows a calendar 472 for selecting the time parameter. In this example, the user selected the week of October 29 of the current year as the time parameter. The user can then select a particular television series by clicking on the corresponding icon.

Of course the operation space 440 and 441, 441′, and 441″ are shown merely as examples. Other graphical user interfaces may also be implemented to enable the user to select various parameters, such as time, space, and/or other parameters. Producing such graphical user interfaces are well-within the ability of one having ordinary skill in the art after becoming familiar with the teachings herein. As discussed above, the user-selection is then used to identify a position in the continuum and retrieve digital media for the user.

It is noted that the user does not need to input each parameter for identifying a position in the continuum. Instead, one or more parameters may be identified. For example, the default geographical location may be identified using data from a global positioning system on the user's mobile phone. Or for example, the user's age/sex can be determined from a user's profile. The user may also link to other profiles (e.g., friends, relatives, etc.). The user may also personalize space-time continuums with custom maps and associate them with favorite digital content (e.g. media products and/or services). The user is also enabled to share personal space-time continuum with other shoppers.

The systems and methods have been described above with reference to e-commerce, however, it is noted that in other embodiments the systems and methods described herein may be implemented using a kiosk or other device at a retailer's “brick-and-mortar” store.

It is noted that the exemplary systems discussed above are provided for purposes of illustration. Still other embodiments are also contemplated.

### Exemplary Operations

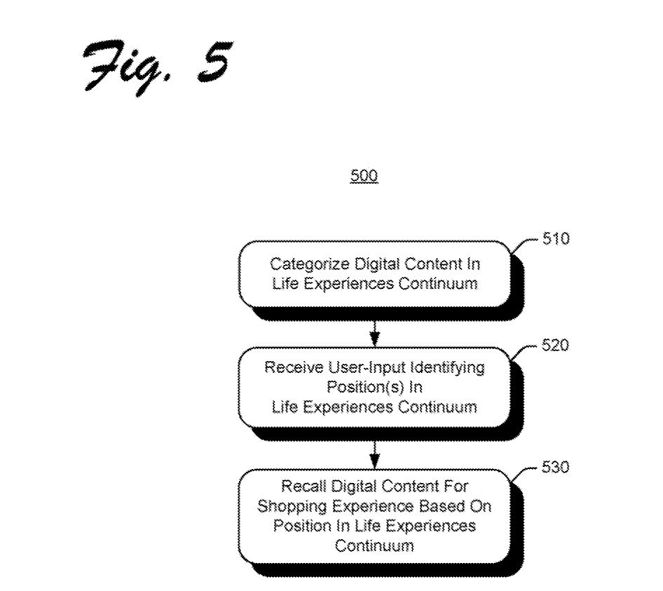

FIG. 5 is a flowchart illustrating exemplary operations which may be implemented for connecting life experiences to a shopping experience. Operations 500 may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used for connecting life experiences to a shopping experience.

In operation 510, digital content (e.g., media products and/or services) are categorized in a plurality of positions in the life experiences continuum. In an exemplary embodiment, the digital content may be categorized using a multi-approach (e.g., time and space parameters). Optionally, the digital content may also be categorized by retail venue (e.g., department stores, fine arts galleries, etc.).

In operation 520, user-input is received identifying at least one position in a life experiences continuum. For example, the life experiences continuum may include at least one of the following positions: time positions, space positions, education positions. In operation 530, digital content is recalled for the user's shopping experience based on at least one position selected by the user in the life experiences continuum.

The operations shown and described herein are provided to illustrate exemplary operations for connecting life experiences to a shopping experience. The operations are not limited to the ordering shown. In addition, still other operations may also be implemented as will be readily apparent to those having ordinary skill in the art after becoming familiar with the teachings herein.

All trademarks and copyrights belong to their respective holders. It is noted that the exemplary embodiments shown and described are provided for purposes of illustration and are not intended to be limiting. Still other embodiments are also contemplated for connecting life experiences to a shopping experience.

1. A method of connecting life experiences to a shopping experience, comprising:
receiving user-input identifying at least one position in a life experiences continuum; and
recalling digital content for the shopping experience based on the at least one position selected by the user in the life experiences continuum.

2. The method of claim 1 further comprising categorizing digital content for the shopping experience in a plurality of positions in the life experiences continuum.

3. The method of claim 1 further comprising categorizing digital content for the shopping experience by retail venue.

4. The method of claim 1 wherein at least one position corresponds to user-selected parameters.

5. The method of claim 4 wherein the user-selected parameters are based on real life experiences.

6. The method of claim 4 wherein the user-selected parameters are based on imaginary life experiences.

7. The method of claim 1 further comprising displaying a map interface for a user to select a space parameter.

8. The method of claim 1 further comprising displaying a calendar interface for a user to select a time parameter.

9. The method of claim 1 wherein the life experiences continuum includes at least one of the following positions: time positions, space positions, and education positions.

10. The method of claim 1 further comprising displaying advertising corresponding to the at least one position in the life experiences continuum.

11. The method of claim 1 further comprising receiving at least some automatic input identifying at least one position in a life experiences continuum.

12. The method of claim 11 wherein the automatic input is from a user profile.

13. The method of claim 11 wherein the automatic input is from a GPS device.

14. A system for connecting life experiences to a shopping experience, comprising:
a meta-data database containing a plurality of parameters associated with a plurality of digital content; and
a graphical user interface receiving user-selected parameters, the graphical user interface returning corresponding digital content from the meta-data database for a user based on the user-selected parameters.

15. The system of claim 14 wherein the parameters include at least time and space parameters.

16. The system of claim 14 wherein the parameters include at least education
parameters.

17. The system of claim 14 wherein the meta-data database includes digital content categorized in a plurality of positions in a life experiences continuum.

18. The system of claim 17 wherein the digital content is categorized by retail venue.

19. The system of claim 14 wherein the user-selected parameters are based on real life experiences of the user.

20. The system of claim 14 wherein the user-selected parameters are based on imaginary life experiences.

21. A system for connecting life experiences to a shopping experience, comprising:
means for categorizing digital content for the shopping experience in a plurality of positions in a life experiences continuum; and
means for retrieving digital content for the shopping experience based on at least one position in the life experiences continuum selected by the user.

22. The system of claim 21 further comprising graphical means for receiving user-input identifying the at least one position in the life experiences continuum.

23. The system of claim 21 wherein the graphical means includes a map for selecting a space parameter and a calendar for selecting a time parameter.
